(19) United States
(12) Patent Application Publication
(10) Pub. No.: US 2012/0059651 A1
(43) Pub. Date: Mar. 8, 2012

(54) MOBILE COMMUNICATION DEVICE FOR TRANSCRIBING A MULTI-PARTY CONVERSATION

(75) Inventors: Jonathan Delgado, Seattle, WA (US); Alfredo Alvarez Lamela, Seattle, WA (US)

(73) Assignee: MICROSOFT CORPORATION, Redmond, WA (US)

(21) Appl. No.: 12/876,472

(22) Filed: Sep. 7, 2010

(51) Int. Cl. G10L 15/26

(52) U.S. Cl. 704/235; 704/E15.044

(57) ABSTRACT

A mobile communications device includes a network interface for communicating over a wide-area network, an input/output interface for communicating over a PAN and a display. The communication device also includes one or more processors for executing machine-executable instructions and one or more machine-readable storage media for storing the machine-executable instructions. The instructions, when executed by the one more processors, implement a voice proximity component, a speech-to-text component and a user interface. The voice proximity component is configured to select a first user's voice from among a plurality of user voices. The first user voice belongs to a user who is in closest proximity to the mobile communication device. The speech-to-text component is configured to convert to text in real-time speech received from the first user but not the other users. The user interface is arranged for displaying the text on the display as it received over the PAN from the other mobile communication devices.

### BACKGROUND

Hearing impaired individuals encounter inconveniences when using a telephone or other voice communication device. These individuals require special equipment, such as an electronic teletype device, so that they may read whatever is being “said” by a party at the other end of a call. Alternatively, hearing-impaired individuals may use a third-party telecommunication relay service (TRS) offered by the service provider which, under the American Disabilities Act, provides this service if requested by the hearing-impaired individual. TRS services require a live operator who uses a teletype machine to transcribe speech into text, and perhaps also to transcribe text into speech. To access a TRS service, the hearing-impaired individual dials a special TRS telephone number to establish a connection with the TRS operator. When initially contacted to place a call, the operator will complete the second leg of the call to the called party. An impaired or non-impaired person may initiate the call to an impaired or non-impaired individual by calling a TRS operator.

These techniques used by the hearing impaired both share a common drawback: they are only useful and efficient in a two party communication. If, for instance, a hearing impaired individual attends a meeting with multiple other participants, it is difficult for them to follow more than one speaker at a time, making it difficult for them to participate in team or collaborative work.

### SUMMARY

A hearing-impaired individual who wishes to participate in an in-person meeting with other participants can do so using a mobile communication device such as a mobile phone or the like, provided that the other participants also have a mobile communication device. First, the devices can use a short-reach communication protocol such as Bluetooth™ to establish a personal area network (PAN) among themselves. Each communication device can determine the particular participant who is using it. In one implementation this can be accomplished by detecting the loudest voice, which can be reasonably assumed to belong to the closest participant, who in turn is most likely to be the participant to whom the device belongs. Each mobile communication device can then convert into text the speech received from its respective participant. The text can then be sent over the PAN to the communication device of the hearing-impaired individual (and possibly the communication devices of the other participants as well), where it can be displayed so that it can be read by the hearing-impaired individual.

In one particular implementation, a mobile communications device is provided which includes a network interface for communicating over a wide-area network, an input/output interface for communicating over a PAN and a display. The communication device also includes one or more processors for executing machine-executable instructions and one or more machine-readable storage media for storing the machine-executable instructions. The instructions, when executed by the one more processors, implement a voice proximity component, a speech-to-text component and a user interface. The voice proximity component is configured to select a first user's voice from among a plurality of user voices. The first user voice belongs to a user who is in closest proximity to the mobile communication device. The speech-to-text component is configured to convert to text in real-time speech received from the first user but not the other users. The user interface is arranged for displaying the text on the display as it received over the PAN from the other mobile communication devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an illustrative operating environment in which three individuals equipped with mobile communication devices are attending a meeting.

FIG. 2 shows one example of a Bluetooth point-to-multipoint PAN.

FIG. 3 shows one illustrative example of a mobile communication device.

FIG. 4 shows the components of one illustrative example of a communications transcriber application.

FIG. 5 is a flowchart illustrating one example of a method by which a communications device participates in a PAN and transcribes the conversation of participants in a conference, meeting or the like.

### DETAILED DESCRIPTION

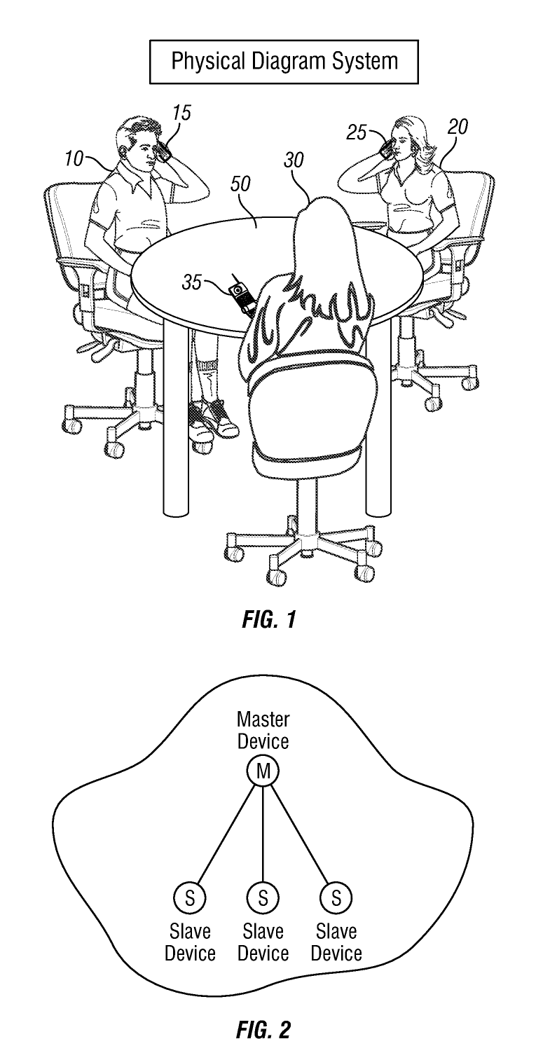

FIG. 1 shows an illustrative operating environment in which three individuals 10, 20 and 30 are attending a meeting. All the attendees are in physically close proximity to one another. That is, the participants are in sufficiently close proximity to one another that they can hear speech spoken by the other participants. In this case, for instance, individuals 10, 20 and 30 are all seated around a conference table 50. Each of the individuals 10, 20 and 30 has a respective mobile communication device 15, 25 and 35. The mobile communication devices may be virtually any portable computing device capable of communicating over a wireless wide-area network. Such devices include, for instance, cellular telephones, smart phones, display pagers, radio frequency (RF) devices, infrared (IR) devices, personal digital assistants (PDAs), handheld computers, laptop computers, wearable computers, tablet computers, integrated devices combining one or more of the preceding devices, and the like.

In addition to communicating over a wide-area network, mobile communication devices 15, 25 and 35 are capable of establishing or entering into a personal area network (PAN) 40 with one another. A PAN is a collection of mobile and desktop electronic devices in a home, personal, or business setting using wireless technology to exchange data and voice over short distances. Bluetooth wireless communications networks are one method for implementing PANs. Bluetooth is a specification for wireless communications using a frequency hopping scheme as the access method which has a range of up to about 10 meters. The wavelengths used are located in the unlicensed 2.4 GHz, Industrial Scientific Medical (ISM) band. In the following disclosure, the term Bluetooth network means a wireless communications network having the capability of operating according to the Bluetooth specification.

The original intention of the Bluetooth specification was to eliminate cables between devices such as telephones, Personal Computer (PC) cards, and wireless headsets by supporting communication over a radio interface. Today, the Bluetooth specification defines a true ad hoc wireless network intended for both synchronous traffic (e.g., voice) and asynchronous traffic (e.g., Internet Protocol (IP) based data). The intention, in a PAN, such as Bluetooth, is that commodity devices, such as telephones, Personal Digital Assistants (PDAs), laptop computers, digital cameras, video monitors, printers, and fax machines will be able to communicate over the radio interface by means of hardware and associated software designed according to a standard specification. Although the PAN 40 may be a Bluetooth compliant network, the PAN 40 is not limited to a Bluetooth PAN and may, for example, comprise an Ultrawide Band (“UWB”) network or other suitable network. For instance, in other embodiments, infrared (IR) or 802.11 communications may be used. For purposes of illustration, however, the PAN 40 will be depicted as a Bluetooth PAN for purposes of the following discussion.

FIG. 2 shows an example of a Bluetooth point-to-multipoint PAN 60. While this example shows a master-slave relationship, a a peer-to-peer PAN may be employed as well. Two or more Bluetooth-enabled devices that share the same channel form a PAN. That is, a PAN is a collection of devices connected via Bluetooth wireless technology in an ad hoc fashion. Within a PAN a Bluetooth device can have either of two roles: master or slave. Within each PAN there is typically only one master, and at least one active slave device. A master device is the device in a PAN whose clock and address are used to synchronize all other devices in the PAN. The Bluetooth system supports both point-to-point and point-to-multi-point connections. Accordingly, there may be up to seven active slave devices in a PAN. That is, a PAN starts with two connected devices, such as a portable PC and a cellular telephone, and may grow to eight connected devices. Typically, Bluetooth devices are peer units and have identical implementations. Also typically, each Bluetooth device can become the master in a PAN. However, when establishing a PAN, one device acts as a master, and the other device or devices act as slaves for the duration of the PAN connection. In operation, the master device polls the slave devices periodically to confirm that the slave devices are on line and to facilitate data transfer. This polling (i.e., scan rate) varies according to the number and type of other devices with which a given device must communicate as well as the communication requirements of the devices involved.

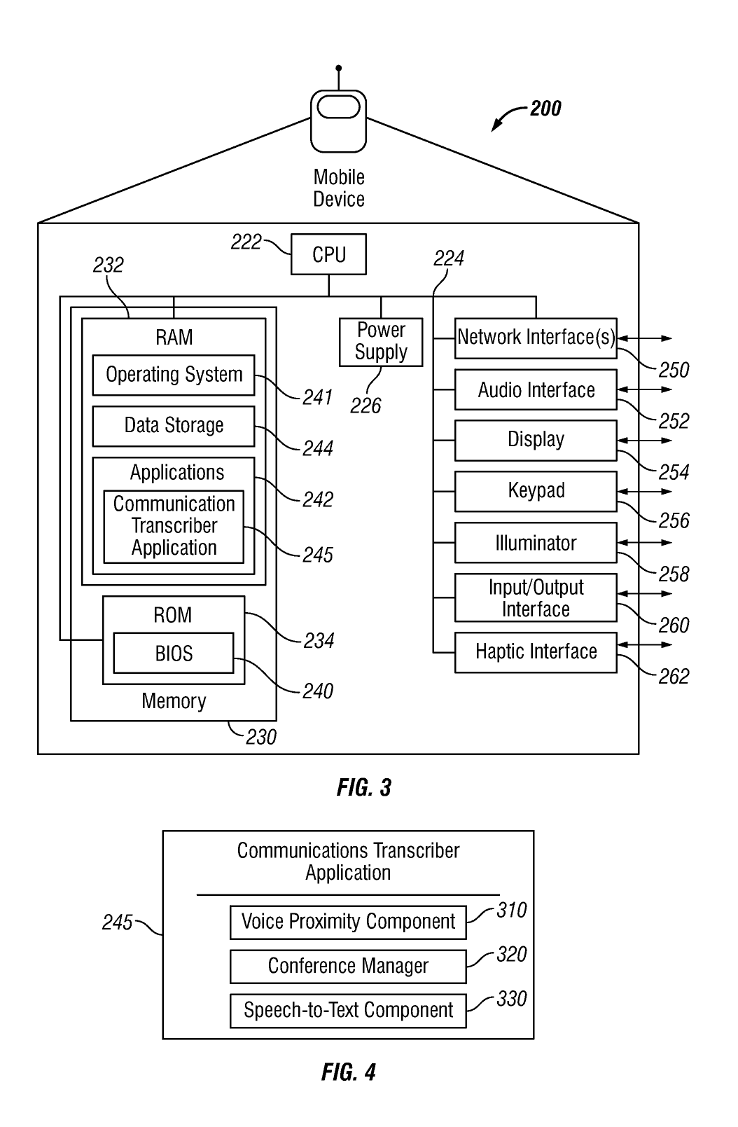

FIG. 3 shows one illustrative example of a mobile communication device 200. Mobile communication device 200 may include many additional or fewer components than those shown in FIG. 3. Mobile communication device 200 may represent, for example, mobile communication devices 15, 25 and 35 of FIG. 1. As shown, mobile communication device 200 includes a processing unit (CPU) 222 in communication with a mass memory 230 via a bus 224. Mobile communication device 200 also includes a power supply 226, one or more network interfaces 250, an audio interface 252, a display 254, a keypad 256, an input/output interface 260 and a haptic interface 262. Power supply 226 provides power to mobile communication device 200. A rechargeable or non-rechargeable battery may be used to provide power. The power may also be provided by an external power source, such as an AC adapter or a powered docking cradle that supplements and/or recharges a battery.

Mobile communication device 200 may optionally communicate with a base station (not shown), or directly with another computing device. Network interface 250 includes circuitry for coupling mobile communication device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wire less communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. Keypad 256 may comprise any input device arranged to receive input from a user. For example, keypad 256 may include a push button numeric dial, a physical keyboard, a virtual on-screen keyboard and so on. Keypad 256 may also include command buttons that are associated with selecting and sending images. Haptic interface 262 is arranged to provide tactile feedback to a user of the client device. For example, the haptic interface may be employed to vibrate mobile communication device 200 in a particular way when another user of a computing device is calling.

Mobile communication device 200 also comprises input/output interface 260 for participating in a PAN with external devices, such as a headset, or other input or output devices not shown in FIG. 2. Input/output interface 260 can utilize one or more communication technologies, such as USB, infrared, Bluetooth™, or the like. By participate, it is meant that the communication device can detect PAN-enabled devices geographically proximate to it with which the communication device can establish a communications connection over which the device can transmit and receive data. Typically, the geographic proximity between two communication devices in the PAN does not exceed 100 meters, although this distance is not limited to the precise communications characteristics of any particular short-range radio frequency communications system used to establish the PAN. Rather, the methods, techniques and devices presented herein contemplate the characteristics of any suitable short-range radio frequency communications system with which the PAN can be established.

Mass memory 230 includes a RAM 232, a ROM 234, and perhaps other storage media. Mass memory 230 illustrates an example of computer storage media for storage of information such as computer readable instructions, data structures, program modules or other data. Mass memory 230 stores a basic input/output system (“BIOS”) 240 for controlling low-level operation of mobile communication device 200. The mass memory also stores an operating system 241 for controlling the operation of mobile communication device 200. The operating system may include, or interface with a virtual machine module that enables control of hardware components and/or operating system operations via a suitable application such as a Java, Python or Ruby application program, for example.

Memory 230 further includes one or more data storage media 244, which can be utilized by mobile communication device 200 to store, among other things, applications 242 and/or other data. For example, data storage 244 medium may also be employed to store information that describes various capabilities of mobile communication device 200. Applications 242 located in memory 230 may include computer executable instructions which, when executed by mobile communication device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth.

One application that may be stored in memory 230 is communication transcriber application 245. Although illustrated in FIG. 3 as an application, the communication transcriber may also be implemented, for instance, in hardware or a combination of hardware and software. Alternatively, all or part of the communication transcriber application may be a component of another application or even operating system 241. FIG. 4 shows three components of one illustrative example of the communications transcriber application 245: voice proximity component or module 310, conference manager 320 and speech-to-text component or module 330.

Voice proximity component 310 is configured to determine which individual is located most closely to the communication device 200. The communication device can be reasonably assumed to belong to and be in use by the person closest to it. In one implementation the voice proximity component may make this determination by examining the volume of the voices of the various individuals in the room. For instance, the loudest voice may be assumed to belong to the individual who is using that particular communication device. Of course, voice proximity component 310 may use other techniques such as voice recognition and the like to determine which individual is located most closely to the communication device 200. In one alternative embodiment, instead of a voice proximity component, voice recognition software may be used to identify the voice of the user to whom the communication device belongs.

The speech-to text component 330 of the communication transcriber application 245 is configured to transcribe speech received by the microphone in the communication device and display text representative of the speech on the display 254. The conversation may be transcribed and displayed in substantially real-time to enable the individual to view the transcription during the conversation and store it for later reference. Conference manager 320 is configured to control overall operation of the communication transcriber application 245 and thereby communicates with both the voice proximity component 310 and the speech-to-text component 330. Conference manager 320 may also include a graphical user interface that enables the user to selectably turn the transcription feature on and off, select a language from which the transcription is being performed, and so on. Of course, the graphical user interface may be a separate component from the conference manager 320.

In one alternative implementation all or part of the functionality of the communication transcriber application 245 may reside on a server that is in communication with the communication device. Off loading the transcription process in this manner may provide a number of advantages, including conserving processing power on the communication device. The communication device may communicate with the server over a wireless network such as the PAN or a cellular network and/or other networks such as the Internet.

The following scenario will be used to illustrate the manner in which the communication transcriber application 245 may be used during a meeting in which one of the attendees or participants is hearing impaired. First, a PAN is established among all the communication devices of the attendees. The details of this process will depend on the particular technology that is used to implement the PAN. Optionally, the user may establish an association between him or herself and the communication device by entering his or her name via the user interface of the communication transcriber application. In this way each attendee can be identified by name on the transcript that is created.

As the attendees begin to speak each communication device, which for convenience may be set on speaker mode, will identify the loudest voice and treat that voice as belonging to the attendee who is using that device. Each device will then convert the speech of its respective user into text Importantly, the devices will not convert speech of any of the other participants except the user in possession of the device. In fact, in order to enhance the fidelity of the transcription process signal processing techniques may be used to filter out the other voices prior to converting the speech to text.

To ensure near real-time transcription, as each spoken word (or some other larger or smaller segment of speech) is transcribed into text it is transmitted over the PAN to all the other communication devices. A time-stamp is appended to each word or other text segment so that the receiving communication devices can reconstruct the text in the proper order. Also appended to each word or other text segment is an identifier identifying the communication device that sent the word. If the user has entered his or her name into the device via the user interface of the communication transcriber application, then the name will be used as the identifier that is sent.

As the words are received they are presented in temporal order on the display of the communication device that belongs to the hearing impaired attendee. In this way a transcript of the entire conversation among the attendees is created. The transcript may also be presented on the display of the other attendee's communication devices. However, the user interface of the transcriber application may include an option that allows each individual to prevent the text from being displayed.

If the hearing impaired attendee is also speech impaired, he or she may communicate with the other attendees by typing or otherwise entering text into his or her communication device. The text is then transmitted to the other communication devices over the PAN so that it can be presented to the other attendees. Alternatively, or in addition thereto, the text may be converted to speech by the speech-to-text component (either in the hearing-impaired attendee's communication device or in the communication devices of the other attendees) and audibly rendered in real time.

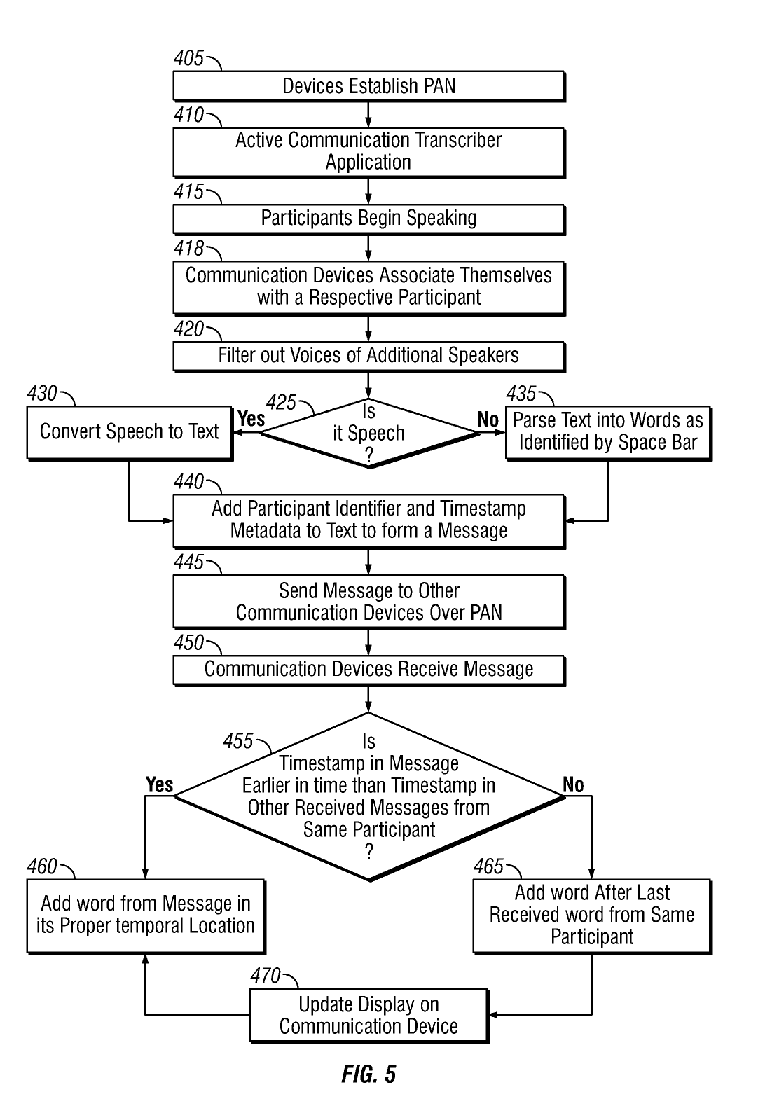

FIG. 5 is a flowchart illustrating one example of a method by which a communications device participates in a PAN and transcribes the conversation of participants in a conference, meeting or the like. First, in step 405 a PAN is established among the communication devices of the participants. A PAN-enabled device entering a PAN can electronically detect the presence of the PAN using, for example conventional service discovery protocols. Service discovery protocols are well-known in the art and allow devices in ad hoc peer-to-peer networks to dynamically discover devices and services. As such, service discovery architectures enable self-configuring dynamic networks by providing a standard method for applications, services and devices to describe and to advertise their capabilities to other applications, services and devices and to discover their capabilities. Service discovery architectures also enable applications, services and devices to search other applications, services or devices for a particular capability, and to request and establish interoperable sessions with them to utilize those capabilities. Among other things, the devices synchronize their clocks to establish a common time. In the case of Bluetooth, the clocks will typically be synchronized to the master device.

Returning now to FIG. 5, in step 410 the communication transcriber application in the communication devices is activated and the various user inputs such as the user's name and transcription and display settings are received. In step 415 the participants begin speaking and in step 418 each device associates itself with its respective participant. As previously mentioned, in one implementation this association may be established by selecting the loudest voice. Next, in step 420 each communication device performs signal processing to filter out or otherwise eliminate all voices except the one with which it is associated.

Since the various participants may communicate via either voice or text, the communication manager determines in step 425 if the communication received from its respective participant is speech or text. If it is speech, then at step 430 the speech is converted to text as it is received. Alternatively, if the participant is communicating by inputting text, then at step 435 each individual word is parsed by locating points at which a space has been provided using the space bar. Once an individual word is made available in text, metadata is added to it in step 440 to form a message. The metadata may include, for instance, a timestamp and a device or participant identifier. The participant identifier may be a name if it has been provided to the communication manager. The message is then sent to the other communication devices over the PAN in step 445 and received by the devices in step 450. As the various messages are received they are sequentially ordered in a transcript that is presented on the display of the devices. This can be accomplished, as in step 455, by examining the time stamp of each message to determine if it is earlier in time than any other message previously received from this participant. If so, then in step 460 it is added in its appropriate location in the transcript after the message from this participant with a timestamp immediately preceding its own timestamp and before any messages from this participant with a later timestamp. Otherwise, in step 465 the word is added after the last word in the transcript which is associated with that participant. Finally, in step 470 the display is updated to include the last received message.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or storage media. For example, computer readable media can include but are not limited to magnetic storage devices (e.g., hard disk, floppy disk, magnetic strips . . .), optical disks (e.g., compact disk (CD), digital versatile disk (DVD) . . .), smart cards, and flash memory devices (e.g., card, stick, key drive . . .). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for facilitating a conversation among a plurality of participants in sufficiently close proximity to one another to hear speech spoken by the other participants, each of said participants having a mobile communication device, comprising:
establishing a personal area network (PAN) with a plurality of mobile communication devices associated with the participants;
receiving speech from a plurality of participants by a microphone in a first of the mobile communication devices;
associating a first participant with the first mobile communication device based at least in part on the received speech;
converting a plurality of segments of speech received from the first participant and no other participants into a plurality of respective segments of text as it is being received;
appending metadata to each of the plurality of text segments to form a first plurality of messages that each correspond to one of the text segments; and
transmitting over the PAN the messages to the plurality of mobile communication devices for presentation to the participants associated therewith.

2. The method of claim 1 wherein associating a first participant with a first mobile communication device includes selecting a participant who is in closest proximity to the first mobile communication device.

3. The method of claim 2 wherein selecting the participant who is in closest proximity to the first mobile communication device includes selecting a participant whose received speech is louder in volume than speech received from any of the other participants .

4. The method of claim 1 wherein associating a first participant with a first mobile communication device is performed by voice recognition software.

5. The method of claim 1 wherein converting the segments of speech includes converting the segments of speech on the first mobile communication device.

6. The method of claim 1 wherein converting the segments of speech includes converting the segments of speech on a server that communicates with the first mobile communication device over a network.

7. The method of claim 1 wherein at least one of the text segments is a word.

8. The method of claim 1 wherein the PAN is a Bluetooth-enabled network.

9. The method of claim 1 further comprising:
receiving a second plurality of messages that each include a second segment of text, an identifier of a participant who second speech segment was transcribed into the respective second segment of text, and a timestamp indicative of a time when the second speech segment was spoken;
selecting a third plurality of messages from among the second plurality of messages which all have a common identifier;
extracting the second text segments from the third plurality of messages; and
displaying the second text segments in a sequential order determined by their respective timestamps.

10. A method for facilitating a conversation among a plurality of participants in sufficiently close proximity to one another to hear speech spoken by the other participants, each of said participants having a mobile communication device, comprising:
receiving from a plurality of the mobile communication devices over a PAN a first plurality of messages that each include a first segment of text, an identifier of a participant who speech segment was transcribed into the respective first segment of text, and a timestamp indicative of a time when the first speech segment was spoken;
selecting a second plurality of messages from among the first plurality of messages which all have a first common identifier;
extracting the second text segments from the second plurality of messages;
displaying the second text segments in a sequential order determined by their respective timestamps.

11. The method of claim 10 further comprising:
selecting a third plurality of messages from among the first plurality of messages which all have a second common identifier;
extracting third text segments from the third plurality of messages;
displaying the third text segments in a sequential order determined by their respective timestamps.

12. The method of claim 11 wherein displaying the second and third text segments includes displaying the second and third text segments in a common sequential order determined by their respective timestamps.

13. The method of claim 11 further comprising displaying the second common identifier along with the third text segments.

14. The method of claim 10 further comprising:
receiving speech from a plurality of participants by a microphone in a first of the mobile communication devices;
associating a first participant with the first mobile communication device based at least in part on the received speech;
converting third segments of speech received from the first participant and no other participants into respective third segments of text as it is being received;
appending metadata to each of the third text segments to form a first plurality of messages that each correspond to one of the third text segments; and
transmitting over the PAN the messages to the plurality of mobile communication devices for presentation to the participants associated therewith.

15. The method of claim 14 wherein associating a first participant with a first mobile communication device includes selecting a participant who is in closest proximity to the first mobile communication device.

16. The method of claim 15 wherein selecting the participant who is in closest proximity to the first mobile communication device includes selecting a participant whose received speech is louder in volume than speech received from any of the other participants.

17. The method of claim 10 wherein the PAN is a Bluetooth-enabled network.

18. A mobile communications device, comprising:
a network interface for communicating over a wide-area network;
an input/output interface for communicating over a PAN;
a display;
one or more processors for executing machine-executable instructions; and
one or more machine-readable storage media for storing the machine-executable instructions, the instructions when executed by the one more processors implementing,
a) a voice proximity component configured to select a first user voice from among a plurality of user voices, said first user voice belonging to a first user who is in closest proximity to the mobile communication device;
b) a speech-to-text component configured to convert to text in real-time speech received from the first user but not other users;
c) a user interface arranged for displaying on the display text as it received over the PAN from other mobile communication devices.

19. The mobile communications device of claim 18 wherein selecting the user who is in closest proximity to the mobile communication device includes selecting a user whose received speech is louder in volume than speech received from any other users.

20. The mobile communications device of claim 18 further comprising a conference manager component configured to select a second plurality of messages from among a first plurality of messages received by the input/output interface, which second plurality of messages all have a common identifier identifying a speaker, wherein the conference manager component is further configured to extract text segments from the second plurality of messages which are displayed as the text on the display.
